(19) United States
(12) Patent Application Publication
(10) Pub. No.: US 2022/0234897 A1
(43) Pub. Date: Jul. 28, 2022

(54) METHOD OF PRODUCING GRAPHITE PRODUCT AND COMPOSITION FOR PRODUCTION OF GRAPHITE PRODUCT

(71) Applicant: KANEKA CORPORATION, Osaka (JP)

(72) Inventor: Yasushi NISHIKAWA, Settsu-shi (JP)

(73) Assignee: KANEKA CORPORATION, Osaka (JP)

(21) Appl. No.: 17/658,377

(22) Filed: Apr. 7, 2022

Related U.S. Application Data
(63) Continuation-in-part of application No. PCT/JP2020/038118, filed on Oct. 8, 2020.

(30) Foreign Application Priority Data
Oct. 8, 2019 (JP) 2019-184936
Oct. 8, 2019 (JP) 2019-184937

(51) Int. Cl. C01B 32/205

(52) U.S. Cl. CPC C01B 32/205

(57) ABSTRACT

A method of producing a graphite product using high-temperature heat treatment is capable of producing a high-quality graphite product without using any resin as a raw material or without the need for the resin used to be a special kind of resin. The method of producing a graphite product includes a step of heat-treating a raw material at a temperature of 2400° C. or higher. The raw material contains graphene oxide (A) and optionally a resin (B). The graphene oxide (A) has a carbon-to-oxygen mass ratio (C/O) of 0.1 to 20. In the raw material, the content of the graphene oxide (A) may be from 0.3 to 20% by weight or may be from 50 to 100% by weight. The graphene oxide (A) may have an average particle size of 2 to 40 μn.

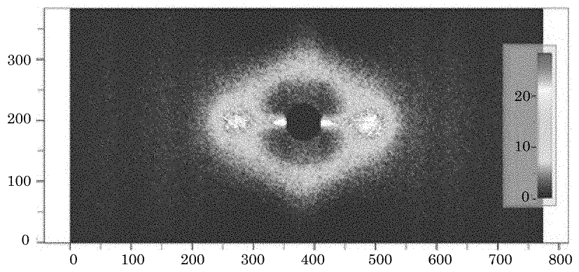

### TECHNICAL FIELD

The present application relates to a method of producing a graphite product and a composition used for production of a graphite product.

### BACKGROUND ART

Graphite is a material having high heat resistance, high chemical resistance, high thermal conductivity, and high electrical conductivity. In particular, graphite films made of crystalline graphite have been recently used as heat-dissipating members for semiconductor elements or other heat-generating parts included in various types of electrical and electronic devices such as computers and smartphones.

A known method of producing a graphite film is so-called expansion graphitization. In this method, first, natural graphite is immersed in a liquid mixture of concentrated sulfuric acid and concentrated nitric acid and rapidly heated into expanded graphite. Subsequently, the expanded graphite is washed to remove the acids and processed into a film form by high-pressure pressing, and thus a graphite film is produced. However, the graphite film produced by this method has a low strength and cannot exhibit satisfactory levels of physical properties. There are also problems such as the influence of the residual acids.

To solve the problems as described above, a method has been developed in which a special resin film is graphitized by heat-treating it at a high temperature (see Patent Literature 1, for example). Examples of the resin film used in this method include films containing polyoxadiazole, polyimide, polyphenylene vinylene, polybenzimidazole, polybenzoxazole, polythiazole, or polyamide. This method is much simpler than the expansion graphitization, and the resulting graphite film is essentially free of impurities such as acids and further has the advantage of high thermal conductivity and electrical conductivity close to those of single-crystal graphite.

Patent Literature 2 teaches processing a molded body containing a resin and an expanded graphite powder into a heat-dissipating molded body by carbonizing the resin component. However, this literature merely teaches carbonization at temperatures up to 800° C., and fails to teach or suggest graphitization which requires a high temperature of 2400° C. or higher.

### CITATION LIST

### Patent Literature

PTL 1: Japanese Laid-Open Patent Application Publication No. 2004-123506

PTL 2: Japanese Laid-Open Patent Application Publication No. 2001-122663

### SUMMARY

### Technical Problem

In conventional methods of producing a highly crystalline graphite product through resin graphitization by high-temperature heat treatment, the resin usable as a raw material is limited to particular types, and a special kind of resin needs to be used.

In view of the above circumstances, the present invention aims to provide a method of producing a graphite product using high-temperature heat treatment, the method being capable of producing a high-quality graphite product without using any resin as a raw material or without the need for the resin used to be a special kind of resin.

### Solution to Problem

As a result of intensive studies, the present inventors have found that high-temperature heat treatment of a raw material composed primarily of graphene oxide can produce a high-quality graphite product superior in properties such as thermal diffusivity without the need for the raw material to contain any resin or without the need for the resin contained in the raw material to be a special kind of resin. Based on this finding, the inventors have arrived at the present invention.

Specifically, the present invention relates to a method of producing a graphite product, the method including the step of heat-treating a raw material at a temperature of 2400° C. or higher, wherein the raw material contains graphene oxide (A), and the graphene oxide (A) has a carbon-to-oxygen mass ratio (C/O) of 0.1 to 20.

Preferably, the raw material is composed of a resin composition further containing a resin (B). More preferably, in X-ray diffractometry, the raw material has an orientation peak of the graphene oxide in a small angle region and an orientation peak of the resin in a large angle region.

Preferably, the carbon-to-oxygen mass ratio (C/O) of the graphene oxide (A) is 1.1 or more and less than 3.5.

Preferably, the graphene oxide (A) has an average particle size of 2 to 40 μm.

Preferably, the resin composition contains 0.3 to 20% by weight of the graphene oxide (A) based on 100% by weight of the resin composition.

Preferably, the raw material is composed of 50 to 100% by weight of the graphene oxide (A) and 0 to 50% by weight of the resin (B).

Preferably, the resin (B) is at least one selected from the group consisting of a polyacrylonitrile resin, a polyvinyl alcohol resin, a polyvinyl chloride resin, a phenolic resin, an epoxy resin, a melamine resin, an acrylic resin, an amide resin, an amide-imide resin, and an imide resin. More preferably, the resin (B) is a phenolic resin. Even more preferably, the phenolic resin is a resol resin.

Preferably, the step of heat-treating the raw material includes heat-treating the raw material at a temperature of 2800° C. or higher. More preferably, the step of heat-treating the raw material includes heat-treating the raw material at a temperature of 2800° C. or higher while applying a load to the raw material.

Preferably, the raw material is in the form of a film. More preferably, the film has a thickness of 10 nm to 1 mm.

Preferably, the method further includes the step of applying or casting a dispersion containing the graphene oxide (A) onto a base to form the raw material.

Preferably, the raw material is prepared by applying multiple coats each having a thickness of 10 μm or less.

The present invention further relates to a composition for production of a graphite product, the composition containing graphene oxide (A), wherein the graphene oxide (A) has a carbon-to-oxygen mass ratio (C/O) of 0.1 to 20.

Preferably, the composition further contains a resin (B).

Preferably, the carbon-to-oxygen mass ratio (C/O) of the graphene oxide (A) is 1.1 or more and less than 3.5.

Preferably, the graphene oxide (A) has an average particle size of 2 to 40 μm.

### Advantageous Effects

The present application is directed to a method of producing a graphite product using high-temperature heat treatment, the method being capable of producing a high-quality graphite product without using any resin as a raw material or without the need for the resin used to be a special kind of resin.

### BRIEF DESCRIPTION OF DRAWINGS

The FIGURE shows a result of X-ray diffractometry of a raw material film of Example 2.

### DESCRIPTION OF EMBODIMENTS

Hereinafter, a specific embodiment of the present application will be described in detail.

The present embodiment relates to a method of producing a graphite product by heat-treating a raw material containing graphene oxide (A) and optionally a resin (B) at a temperature of 2400° C. or higher and thus graphitizing the raw material. The raw material may consist essentially of the graphene oxide (A) or may be composed of a resin composition containing the graphene oxide (A) and the resin (B).

Graphene is a sheet-shaped material that is composed of sp²-bonded carbon atoms and is one to several carbon atoms thick. The graphene oxide (A) is a graphene material in which a part of the graphene surface is substituted or modified with oxygen or an oxygen-containing functional group such as a hydroxy or carboxy group.

The graphene oxide (A) has a carbon-to-oxygen mass ratio (C/O) of 0.1 to 20. If the mass ratio is less than 0.1, it is difficult to maintain the graphene structure. If the mass ratio is more than 20, the oxygen content in the graphene oxide is so low that it is difficult to produce a high-quality graphite product, in particular a graphite product having a high thermal diffusivity. The mass ratio is preferably 10 or less, more preferably 5 or less, particularly preferably less than 3.5, and most preferably 3.0 or less. As for the lower limit, the mass ratio is preferably 0.6 or more, more preferably 0.7 or more, and particularly preferably 1.1 or more.

In another embodiment, the carbon-to-oxygen mass ratio (C/O) of the graphene oxide (A) may be 0.5 or more and less than 20. In this embodiment, the mass ratio is preferably 10 or less, more preferably 5 or less, and even more preferably 3 or less. As for the lower limit, the mass ratio is preferably 0.6 or more, more preferably 0.7 or more, and even more preferably 1.0 or more.

The carbon-to-oxygen mass ratio (C/O) of the graphene oxide (A) can be measured using a CHN elemental analyzer (PE 240011, manufactured by PerkinElmer, Inc.) for a dry film made of the graphene oxide (A).

The thickness of the graphene oxide (A) is not limited to a particular range, and is preferably 100 nm or less, more preferably 50 nm or less, even more preferably 10 nm or less, and particularly preferably 1 nm or less. The thickness of the graphene oxide (A) can be measured by applying a dispersion of the graphene oxide (A) to a silicon substrate and using a scanning probe microscope (SFM: Dimension Icon, manufactured by Bruker AXS) in a tapping mode.

The average particle size of the graphene oxide (A) is not limited to a particular range, and is preferably from 30 nm to 1 mm, more preferably from 50 nm to 100 μm, even more preferably from 100 nm to 50 μm, still even more preferably from 0.3 μm to 30 μm, and particularly preferably from 2 μm to 40 μm. The average particle size of the graphene oxide (A) can be determined as follows: a dispersion of the graphene oxide (A) is applied to a silicon substrate; the dispersion is observed with a scanning electron microscope (SEM: ULTRA plus manufactured by Zeiss) at an accelerating voltage of 1 kV to obtain a SEM image; a certain number of particles (e.g., 100 particles) are randomly picked up on the SEM image; the particle size of each particle is measured; and the sum of the measured values is divided by the number of the particles to calculate the average particle size.

The graphene oxide (A) used may be a commercially-available product or may be synthesized as appropriate.

The method of synthesis of the graphene oxide (A) is not limited to a particular technique. Examples of the method include: a method in which graphite is oxidized with an oxidant and then the resulting graphite oxide is exfoliated; and a method in which electrolysis is performed using graphite as a working electrode and followed by exfoliation. Examples of the method involving oxidation with an oxidant include Brodie method (in which nitric acid and potassium chlorate are used), Staudenmaier method (in which nitric acid, sulfuric acid, and potassium chlorate are used), and Hummers-Offeman method (in which sulfuric acid, sodium nitrate, and potassium permanganate are used). Examples of the method involving electrolysis include a method in which an aqueous solution of an acid substance such as sulfuric acid, nitric acid, or perchloric acid is used as an electrolyte solution. Examples of the method of exfoliation include application of an external mechanical force, heating treatment, and ultrasonic irradiation.

The resin (B) is not limited to a particular type and may be any organic resin that can form a mixture with the graphene oxide (A) and that can be graphitized by heat treatment at 2400° C. or higher. The use of the resin (B) in combination with the graphene oxide (A) makes it possible to easily obtain a graphite product having a good appearance. The resin (B) may be a thermosetting resin or a thermoplastic resin, and is preferably a thermosetting resin because a thermosetting resin can easily be mixed with the graphene oxide (A) and formed into a film. The thermosetting resin can be used with a curing agent, a curing accelerator, or a curing catalyst, if necessary.

Specific examples of the resin (B) include polyacrylonitrile resins, polyvinyl alcohol resins, polyvinyl chloride resins, phenolic resins, epoxy resins, melamine resins, acrylic resins, amide resins, amide-imide resins, imide resins, glutarimide resins, polystyrene resins, modacrylic resins, pitch, and polyimide resins. One of these resins may be used alone, or two or more thereof may be used in combination. Polyacrylonitrile resins and phenolic resins are preferred as they can easily be mixed with the graphene oxide (A) and formed into a film and are inexpensive. Phenolic resins are more preferred.

Phenolic resins mentioned above are resins obtained by polycondensation of phenol and formaldehyde. A phenolic resin obtained by the polycondensation in the presence of an acid catalyst is a novolac resin, which is a thermoplastic resin. A phenolic resin obtained with the aid of an alkali catalyst is a resol resin. Having self-reactive functional groups, resol resins can be cured by heating and generally exhibit properties as thermosetting resins. The phenolic resin used is preferably a resol resin because a resol resin can easily be mixed with the graphene oxide (A) and formed into a film.

The viscosity of the resin (B) is not limited to a particular range, and is preferably 100 mPa·s or more, more preferably 200 mPa·s or more, and even more preferably 300 mPa·s or more.

The contents of the graphene oxide (A) and the resin (B) in the resin composition are not limited to particular ranges. In an embodiment, the content of the graphene oxide (A) is preferably from 0.3 to 20% by weight, and the content of the resin (B) is preferably from 80 to 99.7% by weight, based on 100% by weight of the resin composition. When the content of the graphene oxide (A) is from 0.3 to 20% by weight, a graphite product with a higher quality can be produced. More preferably, the content of the graphene oxide (A) is from 1 to 15% by weight, and the content of the resin (B) is from 85 to 99% by weight. Even more preferably, the content of the graphene oxide (A) is from 1 to 10% by weight, and the content of the resin (B) is from 90 to 99% by weight.

In another embodiment, the content of the graphene oxide (A) is preferably from 50 to 100% by weight, and the content of the resin (B) is preferably from 0 to 50% by weight, based on 100% by weight of the raw material. When the content of the graphene oxide (A) is 50% by weight or more, a high-quality graphite product is more likely to be obtained. More preferably, the content of the graphene oxide (A) is from 80 to 100% by weight, and the content of the resin (B) is from 0 to 20% by weight. Even more preferably, the content of the graphene oxide (A) is from 90 to 100% by weight, and the content of the resin (B) is from 0 to 10% by weight. In this embodiment, the resin (B) need not be contained in the raw material.

In the production method of the present embodiment, a raw material consisting essentially of the graphene oxide (A) or a raw material composed of a resin composition containing the graphene oxide (A) and the resin (B) is prepared first. The specific method of preparing the raw material is not limited to a particular technique. An exemplary method is to obtain a liquid mixture or dispersion by mixing the graphene oxide (A) and optionally the resin (B) with a solvent or dispersion medium used as necessary, then apply or cast the mixture or dispersion into a thin layer on a base, dry the thin layer, and peel the resulting film from the base. When a commercially-available graphene oxide dispersion is used as the graphene oxide (A), the solvent or dispersion medium need not be added. When a liquid resin, resin solution, or resin dispersion is used as the resin (B), the solvent or dispersion medium need not be added.

Alternatively, a film containing the graphene oxide (A) and the resin (B) may be produced as follows: the graphene oxide (A), a precursor of the resin (B), a reaction accelerator or catalyst used as necessary, and a solvent or dispersion medium used as necessary are mixed to obtain a liquid mixture or dispersion; then the mixture or dispersion is applied or cast as a thin layer on a base; and the thin layer is dried and at the same time the precursor reacts to form the resin (B).

The solvent or dispersion medium is not limited to a particular type, and examples of the solvent or dispersion medium include water, DMF, DMAc, DMSO, dichlorobenzene, toluene, xylene, methoxybenzene, ethanol, propanol, and pyridine.

The base may be a substrate or a film or may be an endless belt or a stainless steel drum. Examples of the method of application of the mixture or dispersion include spin coating or bar coating. The application may be done once or repeated two or more times to give multiple coats of the mixture or dispersion. When a resin-containing film prepared by applying multiple coats of the mixture or dispersion is used as the raw material, a graphite product with a higher thermal diffusivity can be produced. In the case of applying multiple coats, the thickness of each coat is preferably 10 μm or less.

To produce a resin-containing film when the resin (B) is a thermoplastic resin, a method can be used in which the graphene oxide (A) and the resin (B) are melted and kneaded in an extruder, then the kneaded mixture is extruded into the form of a film through a T-die, and the extrudate is cooled and solidified. Examples of the method of melting and kneading include a method using a kneading device such as a twin-screw kneader such as Plastomill, a single-screw extruder, a twin-screw extruder, a Banbury mixer, and a roll mill. The melting and kneading may be followed by pressing to process the kneaded mixture into the form of a film.

The raw material containing the graphene oxide (A) and optionally the resin (B) is not limited to having a particular form and is preferably a film. The thickness of the film is not limited to a particular range, and is, for example, from 10 nm to 1 mm, preferably from 0.1 μm to 500 μm, and more preferably from 1 μm to 300 μm.

The raw material is then heat-treated at a temperature of 2400° C. or higher to produce a graphite product. The heat treatment at 2400° C. or higher induces release of oxygen atoms from the graphene oxide (A) and allows graphitization of the graphene oxide (A) to proceed, and also leads to carbonization and the subsequent graphitization of the resin (B). In one embodiment, since the raw material contains the graphene oxide (A) in addition to the resin (B), the graphene oxide (A) acts as a nucleating agent to increase the crystallinity of the resin (B), and thus a high-quality graphite product can be produced even if the resin (B) is a kind of resin that cannot be used in conventional polymer graphitization. In another embodiment, a high-quality graphite product can be produced despite the raw material containing no or little amount of the resin (B). When the raw material is in the form of a film, a high-quality graphite film can be produced.

The process of the heat treatment will be described in detail. First, the raw material containing the graphene oxide (A) and optionally the resin (B) is preheated in a non-oxidizing atmosphere such as a nitrogen gas atmosphere to carbonize the raw material. This results in a glassy carbon product. Typically, the carbonization step can be accomplished by heating to a temperature in the range of 80° C., preferably 90° C. to 1500° C. The temperature is, for example, 1000° C. The temperature increase rate during heating is not limited to a particular range and, for example, is preferably from 0.1 to 10° C./min. For example, in the case of heating up to 1000° C. at a rate of 10° C./min, it is desirable to hold the carbon product at the temperature of 1000° C. for about 30 minutes. The carbonization step may be performed at a reduced pressure or under a stream of inert gas. The carbonization step may be performed while the raw material is subjected to a load that is low enough not to break the raw material.

Subsequently, the carbon product obtained as above is placed in an ultra-high-temperature furnace and graphitized. In the graphitization step, rearrangement of the graphite layers proceed in the carbon product, resulting in formation of a highly crystalline graphite product. The carbonization and graphitization steps may be performed successively in one and the same furnace. Alternatively, a step of cooling the carbon product may be performed after the carbonization step, and the graphitization step may be performed separately from the carbonization step.

The heating temperature in the graphitization step is 2400° C. or higher, preferably 2700° C. or higher, and more preferably 2800° C. or higher. The graphitization step is desirably performed in an inert gas. The inert gas is not limited to a particular type, and is preferably argon and more preferably a mixture of argon and a slight amount of helium. The temperature increase rate during heating in the graphitization step is not limited to a particular range and, for example, is preferably from 0.1 to 10° C./min. The graphitization step may be performed at a reduced pressure or under a stream of inert gas.

The graphitization step may be performed while a load is applied to the carbon material by means such as a press machine. The graphitization step coupled with the load application can give a graphite product having a higher thermal diffusivity and a better appearance. The load is preferably 1 kg/cm² or more, more preferably 10 kg/cm² or more, and even more preferably 50 kg/cm² or more.

Through the steps as described above, a graphite product having a high thermal diffusivity can be produced by high-temperature heat treatment of a raw material without the need for the raw material to contain any resin or without the need for the resin contained in the raw material to be a special kind of resin.

### EXAMPLES

Hereinafter, the present application will be described in more detail using examples. The present application is not limited to the examples given below.

(Method of Measuring Thermal Diffusivity of Graphite Product)

To measure the thermal diffusivity of the graphite product, the graphite product was cut to prepare a 40×40 mm-sized sample, and this sample was subjected to measurement using a thermal diffusivity measurement device (Thermowave Analyzer TA-3, manufactured by BETHEL Co., Ltd.) at 20° C.

(Method of Evaluating Orientation of Raw Material)

To evaluate the orientation of the raw material, an X-ray diffractometer (SmartLab manufactured by Rigaku Corporation) was used to irradiate the edge of the raw material film with X-rays and measure the WADX of the raw material film. The measurement conditions were as follows. The tube voltage was set to 40 kV, the tube current was set to 50 mA, the scan axis was set to 2θ(incident angle=0°), the measurement mode was set to exposure mode, the camera length was set to 25 mm, the exposure time was set to 5 minutes, the X-ray source was set to CuKα(λ=1.54186 Å), the goniometer length was set to 300 mm, and the optical system was set to parallel beam (double pinhole). For the incidence optics, the 1st pinhole (selection slit) was set to ø0.3 mm, the incidence Soller slit was set to OPEN, the 2nd pinhole (collimator) was set to ø0.1 mm, the 3rd pinhole was set to ø1 mm, and the attachment was set to 2D-SAXS/WAXS attachment+ø base. For the receiving optics, the receiving slit 1 was set to NONE, the parallel slit analyzer was set to NONE, the receiving Soller slit was set to NONE, and the receiving slit 2 was set to OPEN. As for the detector, a two-dimensional detector, HyPix-3000, Monochromation (parabolic multilayer mirror), was used.

(Method of Observing Post-Graphitization Appearance)

The post-graphitization appearance was visually observed. A flat, uniform appearance was rated “A”, a slightly blistered or rough appearance was rated “B”, a somewhat blistered or rough appearance was rated “C”, and a significantly blistered or rough appearance was rated “D”.

### Example 1

A DMF solution (concentration: about 2%) of graphene oxide (average particle size: 1 μm, C/O ratio: 1.2) and a methanol solution of a phenolic resin (a methanol solution of a resol resin, concentration: about 65%, viscosity: 200 mPa·s) were mixed in a solid content ratio of 10:90 (by weight). A coat of the resulting solution was applied onto an aluminum foil such that the thickness of the coat would be 30 μm after drying, and the applied coat was dried at room temperature. After the drying, the aluminum foil was removed with hydrochloric acid, and the coat was washed with water and dried to obtain a 30-μm-thick raw material film.

The obtained raw material film was sandwiched between graphite plates, heated from room temperature to 1000° C. at a rate of 1° C./min in a nitrogen atmosphere, and held at 1000° C. for 10 minutes to carbonize the film. Subsequently, the resulting carbonized film was sandwiched between graphite plates, heated from room temperature to 2000° C. at a rate of 2.5° C./min in a vacuum and then from 2000° C. to 2950° C. at a rate of 2.5° C./min in argon, and held at 2950° C. for 10 minutes to graphitize the film. The graphite product obtained had a thermal diffusivity of 5.7 cm²/s.

TABLE 1

| | | | Example 1 | Example 2 | Example 3 | Example 4 | Example 5 | Example 6 | Example 7 |
|---|---|---|---|---|---|---|---|---|---|
| Resin | Graphene | (A1) Graphene oxide | 10% | 10% | | | | | |
| composition | oxide (A) | 1 μm, C/O = 1.2 | | | | | | | |
| | | (A2) Graphene oxide | | | 10% | 10% | 5% | 1% | 20% |
| | | 10 μm, C/O = 1.2 | | | | | | | |
| | Resin (B) | (B1) Phenolic resin | 90% | 90% | 90% | 90% | 95% | 99% | 80% |
| | | (viscosity: 200 mPa · s) | | | | | | | |

| | | | | | | | | |
|---|---|---|---|---|---|---|---|---|
| Way of application | — | Single | Multiple | Single | Multiple | Single | Single | Single |
| | | coat | coats | coat | coats | coat | coat | coat |
| Graphitization conditions | Maximum temperature | 2950° C. | 2950° C. | 2950° C. | 2950° C. | 2950° C. | 2950° C. | 2950° C. |
| | Pressing | — | | — | | — | | — |
| Graphite product | Thermal diffusivity | 5.7 | 7.6 | 6.0 | 7.8 | 5.5 | 5.2 | 6.0 |
| | (cm²/s) | | | | | | | |

### Example 2

A DMF solution (concentration: about 2%) of graphene oxide (average particle size: 1 μm, C/O ratio: 1.2) and a methanol solution of a phenolic resin (a methanol solution of a resol resin, concentration: about 65%, viscosity: about 200 mPa·s) were mixed in a solid content ratio of 10:90 (by weight). Four coats of the resulting solution were applied onto an aluminum foil such that the total thickness of the coats would be 30 μm after drying. The applied coats were dried first at 60° C. and then at 120° C. After the final drying, the aluminum foil was removed with hydrochloric acid, and the coats were washed with water and dried to obtain a 30-μm-thick raw material film. The orientation of the raw material film obtained was as shown in the FIGURE. The orientations of the graphene oxide and the resin were successfully identified; in particular, the orientation peak of the graphene oxide was observed in a small angle region (where 2θ is 5 degrees or less) and the orientation peak of the resin was observed in a large angle region (where 2θ is 15 degrees or more).

The obtained raw material film was graphitized in the same manner as in Example 1. The graphite product obtained had a thermal diffusivity of 7.6 cm²/s.

### Example 3

A graphite product was produced in the same manner as in Example 1, except that graphene oxide having an average particle size of 10 μm and a C/O ratio of 1.2 was used. The obtained graphite product had a thermal diffusivity of 6.0 cm₂/s.

### Example 4

A graphite product was produced in the same manner as in Example 2, except that graphene oxide having an average particle size of 10 μm and a C/O ratio of 1.2 was used. The obtained graphite product had a thermal diffusivity of 7.8 cm²/s.

### Examples 5 to 7

In Examples 5, 6, and 7, graphite products were produced in the same manner as in Example 3, except that the proportion (by weight) of the graphene oxide was changed to 5%, 1%, and 20%. The obtained graphite products had thermal diffusivities of 5.5 cm²/s, 5.2 cm²/s, and 6.0 cm²/s, respectively.

### Examples 8 to 11

In Examples 8, 9, 10, and 11, graphite products were produced in the same manner as in Example 3, except that the graphene oxide used was different from the graphene oxide of Example 3 (average particle size: 10 μm, C/O ratio: 1.2). In Example 8, the graphene oxide had an average particle size of 30 μm and a C/O ratio of 1.2. In Example 9, the graphene oxide had an average particle size of 50 μm and a C/O ratio of 1.2. In Example 10, the graphene oxide had an average particle size of 10 μm and a C/O ratio of 1.0. In Example 11, the graphene oxide had an average particle size of 10 μm and a C/O ratio of 3.5. The obtained graphite products had thermal diffusivities of 5.9 cm²/s, 5.6 cm²/s, 5.9 cm²/s, and 5.7 cm²/s, respectively.

TABLE 2

| | | | Example 8 | Example 9 | Example 10 | Example 11 | Example 12 |
|---|---|---|---|---|---|---|---|
| Resin | Graphene | (A2) Graphene oxide | | | | | 10% |
| composition | oxide (A) | 10 μm, C/O = 1.2 | | | | | |
| | | (A3) Graphene oxide | 10% | | | | |
| | | 30 μm, C/O = 1.2 | | | | | |
| | | (A4) Graphene oxide | | 10% | | | |
| | | 50 μm, C/O = 1.2 | | | | | |
| | | (A5) Graphene oxide | | | 10% | | |
| | | 10 μm, C/O = 1.0 | | | | | |
| | | (A6) Graphene oxide | | | | 10% | |
| | | 10 μm, C/O = 3.5 | | | | | |
| | Resin (B) | (B1) Phenolic resin | 90% | 90% | 90% | 90% | 90% |
| | | (viscosity: 200 mPa · s) | | | | | |

| | | | | | | |
|---|---|---|---|---|---|---|
| Way of application | — | Single | Single | Single | Single | Single |
| | | coat | coat | coat | coat | coat |
| Graphitization | Maximum | 2950° C. | 2950° C. | 2950° C. | 2950° C. | 2900° C. |
| conditions | temperature | | | | | |
| | Pressing | — | | — | — | Screw |
| | | | | | | fastening |
| Graphite product | Thermal diffusivity | 5.9 | 5.6 | 5.9 | 5.7 | 6.7 |
| | (cm²/s) | | | | | |

| | | | Example 13 | Example 14 | Example 15 |
|---|---|---|---|---|---|
| Resin | Graphene | (A2) Graphene oxide | 10% | 10% | 10% |
| composition | oxide (A) | 10 μm, C/O = 1.2 | | | |

(A3) Graphene oxide
30 μm, C/O = 1.2
(A4) Graphene oxide
50 μm, C/O = 1.2
(A5) Graphene oxide
10 μm, C/O = 1.0
(A6) Graphene oxide
10 μm, C/O = 3.5

| | | | | |
|---|---|---|---|---|
| Resin (B) | (B1) Phenolic resin | 90% | 90% | 90% |
| | (viscosity: 200 mPa · s) | | | |

| Way of application | — | Single | | Single | | Multiple | |
|---|---|---|---|---|---|---|---|
| | | coat | | coat | | coats | |
| Graphitization | Maximum | 2900° | C. | 2900° | C. | 2900° | C. |
| conditions | temperature | | | | | | |
| | Pressing | 1 | kg/cm² | 50 | kg/cm² | 50 | kg/cm² |

| | | | | |
|---|---|---|---|---|
| Graphite product | Thermal diffusivity | 7.0 | 7.3 | 7.9 |
| | (cm²/s) | | | |

### Example 12

A graphite product was produced in the same manner as in Example 3, except that: a raw material film identical to that of Example 3 was sandwiched between graphite plates, the four sides of the graphite plates were fastened with screws, and the sandwiched film was carbonized; the resulting carbonized film was sandwiched between graphite plates, the four sides of the graphite plates were fastened with screws, and the sandwiched film was graphitized; and the maximum temperature in the graphitization was changed to 2900° C. The obtained graphite product had a thermal diffusivity of 6.7 cm²/s.

### Example 13

A graphite product was produced in the same manner as in Example 3, except that a raw material film identical to that of Example 3 was sandwiched between graphite plates, the four sides of the graphite plates were fastened with screws, and the sandwiched film was carbonized; the resulting carbonized film was sandwiched between graphite plates and graphitized under a load of 1 kg/cm²; and the maximum temperature in the graphitization was changed to 2900° C. The obtained graphite product had a thermal diffusivity of 7.0 cm²/s.

### Example 14

A graphite product was produced in the same manner as in Example 3, except that a raw material film identical to that of Example 3 was sandwiched between graphite plates, the four sides of the graphite plates were fastened with screws, and the sandwiched film was carbonized; the resulting carbonized film was sandwiched between graphite plates and graphitized under a load of 50 kg/cm²; and the maximum temperature in the graphitization was changed to 2900° C. The obtained graphite product had a thermal diffusivity of 7.3 cm²/s.

### Example 15

A graphite product was produced in the same manner as in Example 4, except that a raw material film identical to that of Example 4 was sandwiched between graphite plates, the four sides of the graphite plates were fastened with screws, and the sandwiched film was carbonized; the resulting carbonized film was sandwiched between graphite plates and graphitized under a load of 50 kg/cm²; and the maximum temperature in the graphitization was changed to 2900° C. The obtained graphite product had a thermal diffusivity of 7.9 cm²/s.

### Example 16

A graphite product was produced in the same manner as in Example 3, except that the methanol solution of the phenolic resin was replaced by a methanol solution of a resol resin (concentration: about 65%, viscosity: 400 mPa·s). The obtained graphite product had a thermal diffusivity of 6.1 cm₂/s.

TABLE 3

| | | | | | | Comp. | Comp. | Comp. |
|---|---|---|---|---|---|---|---|---|
| | | | Example 16 | Example 17 | Example 18 | Example 1 | Example 2 | Example 3 |
| Resin | Graphene | (A2) Graphene oxide | 10% | 10% | 10% | | | |
| composition | oxide (A) | 10 μm, C/O = 1.2 | | | | | | |
| | Resin (B) | (B1) Phenolic resin | | | | 90% | 90% | 100% |
| | | (viscosity: 200 mPa · s) | | | | | | |
| | | (B2) Phenolic resin | 90% | | | | | |
| | | (viscosity: 400 mPa · s) | | | | | | |
| | | (B3) Polyacrylonitrile resin | | 90% | 90% | | | |
| | Expanded | Expanded graphite | | | | 10% | | |
| | graphite | 10 μm | | | | | | |
| | Graphene | Graphene | | | | | 10% | |
| | | 10 μm, C/O = 25 or more | | | | | | |

| Way of application | — | Single | Multiple | Multiple | | Single | Single | Single |
|---|---|---|---|---|---|---|---|---|
| | | coat | coats | coats | | coat | coat | coat |
| Graphitization conditions | Maximum temperature | 2950° C. | 2950° C. | 2900° | C. | 2950° C. | 2950° C. | 2950° C. |
| | Pressing | — | — | 50 | kg/cm² | — | — | — |

| | | | | | | | |
|---|---|---|---|---|---|---|---|
| Graphite product | Thermal diffusivity (cm²/s) | 6.1 | 5.8 | 6.5 | <0.5 | <0.5 | <0.1 |

### Example 17

A graphite product was produced in the same manner as in Example 4, except that the solution used as the raw material was one prepared by mixing a DMF solution (concentration: about 2%) of graphene oxide (average particle size: 10 μm, C/O ratio: 1.2) and a DMF solution (concentration: about 10%) of a polyacrylonitrile resin in a solid content ratio of 10:90 (by weight). The obtained graphite product had a thermal diffusivity of 5.8 cm²/s.

### Example 18

A graphite product was produced in the same manner as in Example 15, except that the solution used as the raw material was one prepared by mixing a DMF solution (concentration: about 2%) of graphene oxide (average particle size: 10 μm, C/O ratio: 1.2) and a DMF solution (concentration: about 10%) of a polyacrylonitrile resin in a solid content ratio of 10:90 (by weight). The obtained graphite product had a thermal diffusivity of 6.5 cm²/s.

### Comparative Example 1

A graphite product was produced in the same manner as in Example 1, except that expanded graphite (average particle size: 10 μm) was used instead of the graphene oxide. The obtained graphite product had a thermal diffusivity of less than 0.5 cm²/s.

### Comparative Example 2

A graphite product was produced in the same manner as in Example 1, except that graphene (average particle size: 10 μm, C/O ratio: 25 or more) was used instead of the graphene oxide. The obtained graphite product had a thermal diffusivity of less than 0.5 cm²/s.

### Comparative Example 3

A graphite product was produced in the same manner as in Example 1, except that a raw material film was prepared using only the methanol solution of the phenolic resin without using the DMF solution of the graphene oxide. The obtained graphite product had a thermal diffusivity of less than 0.1 cm²/s.

### Example 19

A coat of an aqueous solution (concentration: about 1%) of graphene oxide (average particle size: 1 μm, C/O ratio: 1.2) was applied onto an aluminum foil such that the thickness of the coat would be 50 μm after drying, and the applied coat was dried at room temperature. After the drying, the aluminum foil was removed with hydrochloric acid, and the coat was washed with water and dried to obtain a 50-μm-thick raw material film.

The raw material film obtained was sandwiched between graphite plates, heated from room temperature to 1000° C. at a rate of 1° C./min in a nitrogen atmosphere, and held at 1000° C. for 10 minutes to carbonize the film. Subsequently, the resulting carbonized film was sandwiched between graphite plates, heated from room temperature to 2000° C. at a rate of 2.5° C./min in a vacuum and then from 2000° C. to 2950° C. at a rate of 2.5° C./min in argon, and held at 2950° C. for 10 minutes to graphitize the film. The obtained graphite product had a thermal diffusivity of 6.5 cm₂/s.

TABLE 4

| | | | Example 19 | Example 20 | Example 21 | Example 22 | Example 23 | Example 24 | Example 25 |
|---|---|---|---|---|---|---|---|---|---|
| Raw | Graphene | Material | Graphene | Graphene | Graphene | Graphene | Graphene | Graphene | Graphene |
| material | oxide (A) | | oxide | oxide | oxide | oxide | oxide | oxide | oxide |

| | | | | | | | | | | | | | | |
|---|---|---|---|---|---|---|---|---|---|---|---|---|---|---|
| Average particle size | 1 | μm | 10 | μm | 30 | μm | 50 | μm | 10 | μm | 30 | μm | 10 | μm |

| | | | | | | | | |
|---|---|---|---|---|---|---|---|---|
| | C/O | 1.2 | 1.2 | 1.2 | 1.2 | 1.2 | 1.2 | 1.2 |
| | Weight ratio | 100% | 100% | 100% | 100% | 95% | 90% | 100% |
| Resin (B) | Material | — | — | — | — | Polyacrylonitrile | Phenolic | — |
| | | | | | | resin | resin | |
| | Weight ratio | — | — | — | — | 5% | 10% | — |

| | | | | | | | | | | | | | | | |
|---|---|---|---|---|---|---|---|---|---|---|---|---|---|---|---|
| Graphitization | Maximum temperature | 2950° | C. | 2950° | C. | 2950° | C. | 2950° | C. | 2950° | C. | 2950° | C. | 2900° | C. |

| | | | | | | | | |
|---|---|---|---|---|---|---|---|---|
| conditions | Pressing | — | — | — | — | — | — | Screw |
| | | | | | | | | fastening |
| Post-graphitization | Appearance | C | C | C | C | B | B | A |
| appearance | | | | | | | | |
| Graphite product | Thermal diffusivity | 6.5 | 6.8 | 6.9 | 6.8 | 6.4 | 6.7 | 7.7 |
| | (cm²/s) | | | | | | | |

### Example 20

A graphite product was produced in the same manner as in Example 19, except that an aqueous solution (concentration: about 1%) of graphene oxide (average particle size: 10 μm, C/O ratio: 1.2) was used. The obtained graphite product had a thermal diffusivity of 6.8 cm²/s.

### Example 21

A graphite product was produced in the same manner as in Example 19, except that an aqueous solution (concentration: about 1%) of graphene oxide (average particle size: 30 μm, C/O ratio: 1.2) was used. The obtained graphite product had a thermal diffusivity of 6.9 cm²/s.

### Example 22

A graphite product was produced in the same manner as in Example 19, except that an aqueous solution (concentration: about 1%) of graphene oxide (average particle size: 50 μm, C/O ratio: 1.2) was used. The obtained graphite product had a thermal diffusivity of 6.8 cm²/s.

### Example 23

A graphite product was produced in the same manner as in Example 19, except that the solution used as the raw material was one prepared by mixing a DMF solution (concentration: about 2%) of graphene oxide (average particle size: 10 μm, C/O ratio: 1.2) and a DMF solution (concentration: about 10%) of a polyacrylonitrile resin in a solid content ratio of 95:5 (by weight). The obtained graphite product had a thermal diffusivity of 6.4 cm²/s.

### Example 24

A graphite product was produced in the same manner as in Example 19, except that the solution used as the raw material was one prepared by mixing a DMF solution (concentration: about 2%) of graphene oxide (average particle size: 30 μm, C/O ratio: 1.2) and a methanol solution of a phenolic resin (a methanol solution of a resol resin, concentration: about 65%, viscosity: about 200 mPa·s) in a solid content ratio of 90:10 (by weight). The obtained graphite product had a thermal diffusivity of 6.7 cm²/s.

### Example 25

A graphite product was produced in the same manner as in Example 20, except that a raw material film identical to that of Example 19 was sandwiched between graphite plates, the four sides of the graphite plates were fastened with screws, and the sandwiched film was carbonized; the resulting carbonized film was sandwiched between graphite plates, the four sides of the graphite plates were fastened with screws, and the sandwiched film was graphitized; and the maximum temperature in the graphitization was changed to 2900° C. The obtained graphite product had a thermal diffusivity of 7.7 cm²/s.

### Example 26

A graphite product was produced in the same manner as in Example 20, except that a raw material film identical to that of Example 19 was sandwiched between graphite plates, the four sides of the graphite plates were fastened with screws, and the sandwiched film was carbonized; the resulting carbonized film was sandwiched between graphite plates and graphitized under a load of 1 kg/cm²; and the maximum temperature in the graphitization was changed to 2900° C. The obtained graphite product had a thermal diffusivity of 7.9 cm₂/s.

TABLE 5

| | | | Example 26 | Example 27 | Example 28 | Example 29 |
|---|---|---|---|---|---|---|
| Raw | Graphene | Material | Graphene | Graphene | Graphene | Graphene |
| material | oxide (A) | | oxide | oxide | oxide | oxide |

| | | | | | | | | |
|---|---|---|---|---|---|---|---|---|
| Average particle | 10 | μm | 10 | μm | 30 | μm | 10 | μm |
| size | | | | | | | | |

| | | | | | |
|---|---|---|---|---|---|
| | C/O | 1.2 | 1.2 | 1.2 | 1.0 |
| | Weight ratio | 100% | 100% | 100% | 100% |
| Resin (B) | Material | — | — | — | — |
| | Weight ratio | — | — | — | — |

| | | | | | | | | | |
|---|---|---|---|---|---|---|---|---|---|
| Graphitization conditions | Maximum | 2900° | C. | 2900° | C. | 2900° | C. | 2950° | C. |
| | temperature | | | | | | | | |

| | | | | | | | |
|---|---|---|---|---|---|---|---|
| Pressing | 1 | kg/cm² | 50 | kg/cm² | 50 | kg/cm² | — |

| | | | | | |
|---|---|---|---|---|---|
| Post-graphitization | Appearance | A | A | C | C |
| appearance | | | | | |
| Graphite product | Thermal diffusivity | 7.9 | 8.1 | 8.2 | 6.7 |
| | (cm²/s) | | | | |

| | | | | | Comp. |
|---|---|---|---|---|---|
| | | | Example 30 | Example 31 | Example 4 |
| Raw | Graphene | Material | Graphene | Graphene | Graphene |
| material | oxide (A) | | oxide | oxide | |

| | | | | | | |
|---|---|---|---|---|---|---|
| Average particle | 10 | μm | 30 | μm | 10 | μm |
| size | | | | | | |

| | | | | |
|---|---|---|---|---|
| | C/O | 3.5 | 1.2 | >25 |
| | Weight ratio | 100% | 90% | 100% |
| Resin (B) | Material | — | Phenolic | — |
| | | | resin | |
| | Weight ratio | — | 10% | — |

| | | | | | | | |
|---|---|---|---|---|---|---|---|
| Graphitization conditions | Maximum | 2950° | C. | 2900° | C. | 2950° | C. |
| | temperature | | | | | | |

| | | | | |
|---|---|---|---|---|
| Pressing | — | 1 | kg/cm² | — |

| | | | | |
|---|---|---|---|---|
| Post-graphitization | Appearance | C | A | D |
| appearance | | | | |
| Graphite product | Thermal diffusivity | 6.4 | 7.7 | 5.5 |
| | (cm²/s) | | | |

### Example 27

A graphite product was produced in the same manner as in Example 20, except that a raw material film identical to that of Example 19 was sandwiched between graphite plates, the four sides of the graphite plates were fastened with screws, and the sandwiched film was carbonized; the resulting carbonized film was sandwiched between graphite plates and graphitized under a load of 50 kg/cm²; and the maximum temperature in the graphitization was changed to 2900° C. The obtained graphite product had a thermal diffusivity of 8.1 cm²/s.

### Example 28

A graphite product was produced in the same manner as in Example 27, except that an aqueous solution (concentration: about 1%) of graphene oxide (average particle size: 30 μm, C/O ratio: 1.2) was used. The obtained graphite product had a thermal diffusivity of 8.2 cm²/s.

### Example 29

A graphite product was produced in the same manner as in Example 20, except that an aqueous solution (concentration: about 1%) of graphene oxide (average particle size: 10 μm, C/O ratio: 1.0) was used. The obtained graphite product had a thermal diffusivity of 6.7 cm₂/s.

### Example 30

A graphite product was produced in the same manner as in Example 20, except that an aqueous solution (concentration: about 1%) of graphene oxide (average particle size: 10 μm, C/O ratio: 3.5) was used. The obtained graphite product had a thermal diffusivity of 6.4 cm²/s.

### Example 31

A graphite product was produced in the same manner as in Example 26, except that the solution used as the raw material was one prepared by mixing a DMF solution (concentration: about 2%) of graphene oxide (average particle size: 30 μm, C/O ratio: 1.2) and a methanol solution of a phenolic resin (concentration: about 65%, viscosity: about 200 mPa·s) in a solid content ratio of 90:10 (by weight). The obtained graphite product had a thermal diffusivity of 7.7 cm²/s.

### Comparative Example 4

A graphite product was produced in the same manner as in Example 20, except that an aqueous solution of graphene (average particle size: 10 μm, C/O ratio: >25) was used. The obtained graphite product had a thermal diffusivity of 5.5 cm₂/s.

1. A method of producing a graphite product, the method comprising the step of heat-treating a raw material at a temperature of 2400° C. or higher, wherein:
the raw material contains graphene oxide, and
the graphene oxide has a carbon-to-oxygen mass ratio (C/O) of 0.1 to 20.

2. The method according to claim 1, wherein the raw material is composed of a resin composition further containing a resin.

3. The method according to claim 2, wherein in X-ray diffractometry, the raw material has an orientation peak of the graphene oxide in a small angle region where 2θ is 5 degrees or less and an orientation peak of the resin in a large angle region where 2θ is 15 degrees or more.

4. The method according to claim 1, wherein the carbon-to-oxygen mass ratio (C/O) of the graphene oxide is 1.1 or more and less than 3.5.

5. The method according to claim 1, wherein the graphene oxide has an average particle size of 2 to 40 μm.

6. The method according to claim 2, wherein the resin composition contains 0.3 to 20% by weight of the graphene oxide based on 100% by weight of the resin composition.

7. The method according to claim 1, wherein the amount of the graphene oxide in the raw material is 50 to 100% by weight and the amount of the resin in the raw material is 0 to 50% by weight.

8. The method according to claim 2, wherein the resin is at least one selected from the group consisting of a polyacrylonitrile resin, a polyvinyl alcohol resin, a polyvinyl chloride resin, a phenolic resin, an epoxy resin, a melamine resin, an acrylic resin, an amide resin, an amide-imide resin, and an imide resin.

9. The method according to claim 8, wherein the resin is a phenolic resin.

10. The method according to claim 9, wherein the phenolic resin is a resol resin.

11. The method according to claim 1, wherein the step of heat-treating the raw material includes heat-treating the raw material at a temperature of 2800° C. or higher.

12. The method according to claim 11, wherein the step of heat-treating the raw material further includes applying a load to the raw material while heat-treating the raw material at the temperature of 2800° C. or higher.

13. The method according to claim 1, wherein the raw material is in the form of a film.

14. The method according to claim 13, wherein the film has a thickness of 10 nm to 1 mm.

15. The method according to claim 1, further comprising a step of applying or casting a dispersion containing the graphene oxide onto a base to form the raw material.

16. The method according to claim 1, wherein the raw material is prepared by applying multiple coats each having a thickness of 10 μm or less.

17. A composition for production of a graphite product, the composition comprising graphene oxide, wherein
the graphene oxide has a carbon-to-oxygen mass ratio (C/O) of 0.1 to 20.

18. The composition according to claim 17, further comprising a resin.

19. The composition according to claim 17, wherein the carbon-to-oxygen mass ratio (C/O) of the graphene oxide is 1.1 or more and less than 3.5.

20. The composition according to claim 17, wherein the graphene oxide has an average particle size of 2 to 40 μm.
